(19) United States
(12) Patent Application Publication
(10) Pub. No.: US 2010/0176346 A1
(43) Pub. Date: Jul. 15, 2010

(54) PROCESS AND SYSTEM FOR CONDUCTING ISOTHERMAL LOW-TEMPERATURE SHIFT REACTION USING A COMPACT BOILER

(76) Inventors: Nicholas Michael MUSICH, Marietta, GA (US); Raju Subramanian Natarajan, Acworth, GA (US)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 12/352,930

(22) Filed: Jan. 13, 2009

(51) Int. Cl. C01B 3/38; B01J 8/04

(52) U.S. Cl. 252/373; 422/190

(57) ABSTRACT

The invention relates to a process and apparatus for performing steam reforming and water gas shift reaction. Steam reformer product gas comprising H₂O and CO is introduced into a combo-boiler which comprises a shell and tube reactor having at least two tube zones and a common shell zone. One of the tube zones is a shift reaction zone wherein the tubes are filed with a shift reaction catalyst. In this shift reaction zone H₂O and CO are converted into CO₂ and H₂. Cooling medium flowing through the shell side of the combo-boiler maintains the shift reaction zone under substantially isothermal conditions. Another of the tube zones is a first process gas cooling zone wherein the cooling medium undergoes indirect heat exchange with a first process gas, for example, the steam reformer product gas before it is introduced into the shift reaction zone.

### FIELD OF THE INVENTION

The present invention relates generally to hydrogen production processes such as steam reforming of hydrocarbon feed streams like natural gas, and systems for conducting such processes. In addition, the invention relates to production of hydrogen using processes and apparatus that perform water-gas shift reactions, especially so-called low-temperature water-gas shift reactions. In particular, the invention relates to processes and systems for producing hydrogen which involve performing low-temperature water-gas shift reactions on H₂O and CO containing feed streams obtained from steam reforming of hydrocarbon feed streams like natural gas.

### BACKGROUND OF THE INVENTION

Hydrogen gas is produced for a variety of chemical and industrial processes. For example, hydrogen is used as a raw material in ammonia synthesis, methanol synthesis, and hydrogen chloride synthesis. Additionally, hydrogen is used to manufacture hydrogen peroxide and is used in the production of oleochemicals. Further, hydrogen is used to remove sulfur from hydrocarbon fuels such as gasoline and diesel.

One use of hydrogen gas that is of increasing importance is as a fuel for use is electrochemical fuel cells. An electrochemical fuel cell coverts hydrogen, using oxygen as an oxidant, to produce electricity. Being a clean form of energy, it is expected that the use of hydrogen gas as a fuel source will continue to grow, and thus demand for hydrogen gas will continue to increase.

Processes for production of hydrogen gas by conversion of hydrocarbons are well known in the art such as catalytic steam reforming, partial oxidation reforming and autothermal reforming processes. Among these processes, catalytic steam reforming is often used for reforming hydrocarbon streams such as natural gas to produce hydrogen gas and carbon monoxide. This product gas can be used as a synthesis gas in methanol or ammonia production, or can be further treated to increase the hydrogen yield

To increase the yield of hydrogen, the large amount of carbon monoxide gas generate during production of hydrogen from steam-methane reforming, it is conventional to use the water-gas shift reaction. This involves catalytically reacting H₂O and CO to form H₂ and CO₂. This reaction thus allows the conversion of an undesired component, CO, to produce further hydrogen and improve plant efficiency. In addition to recovering otherwise lost hydrogen, the shift reactor is important in fuel cell fuel processing systems because carbon monoxide acts as a severe anode catalyst poison in low-temperature fuel cells, such as solid polymer electrolyte fuel cells. The shift reaction provides a convenient method of reducing the carbon monoxide content of reformer product gases.

The water-gas shift reaction is performed over a catalyst and is favored by low temperatures. However, the temperature must be high enough to prevent condensation of steam on the catalyst. In addition, the reaction generates a significant amount of heat. This generated heat is of particular importance due to the sensitivity of the shift catalyst to deactivation due to sintering. Thus, an integral component of shift reaction operation is precise control of reactor temperature.

EP 0 600 621 discloses a combined steam reformer and shift reactor having a reforming chamber, a low-temperature shift reaction chamber, and a steam generator which are all preferably arranged in a common vessel. The reactor further has means for supplying hydrocarbon containing material to the reforming chamber, means for supplying oxygen containing gas to the reforming chamber, and means for supplying water (steam) to the reforming chamber. The cylindrical reforming chamber is surrounded by an annular chamber which forms the steam generator. The low-temperature shift reaction chamber is a plurality of catalyst-filled tubes which pass through the steam generator. The arrangement permits heat to be transferred from the low-temperature shift reaction chamber to the steam generator. The reactor can also provide for heat exchange to occur between the product from the reforming chamber and at least one of the hydrocarbon, water (steam), and oxygen containing gas before the latter are introduced into the reforming chamber.

In operation, the hydrocarbon material (e.g., methane or natural gas), steam, and oxygen containing gas (e.g. air), are heated and all mixed together in the reforming chamber where the mixture contacts a catalyst suitable for high temperature partial oxidation reforming. This reaction produces reforming product gases comprising hydrogen, carbon dioxide, and carbon monoxide which are then transferred to the low-temperature shift reaction tubes.

The system of EP 0 600 621 exhibits several disadvantages. The concentric arrangement of the reforming chamber and the steam chamber with catalyst-filled tubes makes maintenance difficult, particularly with respect to the reforming catalyst bed. In addition, the mixing of an oxygen containing gas with the hydrocarbon feed and steam and subsequent catalytic partial oxidation of the mixture provides a hydrogen gas product that contains impurities (e.g., N₂) resulting from the use of air as the oxygen containing gas and the byproducts of the oxidation reaction (e.g., conversion of N₂ into ammonia and/or NOₓ). Such impurities could be reduced by the use of pure oxygen as the oxygen containing gas, however this would significantly increase costs.

U.S. Pat. No. 6,641,625 (Clawson et al.), U.S. Pat. No. 6,986,797 (Clawson et al.) and U.S. Pat. No. 7,074,373 (Warren et al.) also discloses processes involving hydrocarbon reforming and shift reaction wherein heat is recovered from the shift reaction to generate steam. However, there is a continuing need increase the efficiency of hydrogen generation via steam reforming and low-temperature shift reaction, in particular with regard to temperature control and heat recovery.

### SUMMARY OF THE INVENTION

In accordance with the invention, to enhance heat recovery and temperature control of the steam reforming/shift reaction process, a common shell/tube boiler design is utilize to cool a plurality of hot process fluid flows through tubes inside of a shell. A heat exchange medium such as water flows through the shell absorbing heat from the tubes. Preferably, during the course of this heat exchange the cooling medium vaporizes. In the case where water is used as the cooling medium, the produced steam can then be utilized in the steam reformer. In accordance with invention, the low-temperature shift reactor is integrated into this common boiler of the waste heat boiler system. The shift reaction catalyst is packed in the tubes of one tube section of the shell/tube boiler while a cooling medium in the combined shell (shared by other tube sections) absorbs the heat generated by the shift reaction. Absorption of the heat of reaction can be controlled so as to maintain the shift reaction in a substantially isothermal state.

Thus, according to a process aspect of the invention, there is provided a process for performing a shift reaction, comprising:

introducing a feed gas comprising H₂O and CO into a combo-boiler comprising a shell and tube reactor having at least two tube zones and a common shell zone, wherein the at least two tube zones include a shift reaction zone and a first process gas cooling zone, the tubes of the shift reaction zone containing a shift reaction catalyst, and wherein the feed gas is introduced into the tubes of the shift reaction zone to convert H₂O and CO into CO₂ and H₂,

introducing a first process gas into the tubes of the first process gas cooling zone,

introducing a cooling medium into the shell side of the combo-boiler for cooling the shift reaction zone and the first process gas cooling zone, wherein the cooling medium undergoes indirect heat exchange with the feed gas and the first process gas, whereby the shift reaction zone is operated under substantially isothermal conditions,

removing a product gas containing CO₂ and H₂ from the tubes of the shift reaction zone,

removing a cooled first process gas from the tubes of the first process gas cooling zone, and

removing the cooling medium from the shell side of the combo-boiler.

According to another process aspect of the invention, there is provided a process for performing steam reforming and a shift reaction, the process comprising;

subjecting a first hydrocarbon feed gas to desulfurization,

introducing the resultant desulfurized first hydrocarbon feed gas and steam into a reforming chamber of a steam reformer, the steam reformer comprising the reforming chamber and a separate burner or combustion chamber, wherein the desulfurized first hydrocarbon feed gas is subjected to steam reforming to produce steam-reformed gas comprising H₂O and CO,

combusting a second hydrocarbon feed gas and an oxygen-containing gas in the burner or combustion chamber of the steam reformer to provide indirect heat for steam reforming the desulfurized first hydrocarbon feed gas,

introducing the steam-reformed gas comprising H₂O and CO into a combo-boiler, the combo-boiler comprising a shell and tube reactor having at least two tube zones and a common shell zone, wherein the at least two tube zones include a shift reaction zone and a first process gas cooling zone, the tubes of the shift reaction zone containing a shift reaction catalyst,

introducing a first process gas into the tubes of the first process gas cooling zone,

introducing steam-reformed gas comprising H₂O and CO into the tubes of the shift reaction zone, wherein the steam-reformed gas undergoes a water-gas shift reaction in said shift reaction zone to convert H₂O and CO into CO₂ and H₂,

introducing a cooling medium into the shell side of the combo-boiler for cooling the shift reaction zone and the first process gas cooling zone, whereby the cooling medium undergoes indirect heat exchange with the first process gas and indirect heat exchange with steam-reformed gas as it undergoes the water-gas shift reaction, whereby the shift reaction zone is operated under isothermal conditions,

removing a product gas containing CO₂ and H₂ from the tubes of the shift reaction zone,

removing a cooled first process gas from the tubes of the first process gas cooling zone, and

removing the cooling medium from the shell side of the combo-boiler.

As noted above, the shift reaction is performed under substantially isothermal conditions through the heat of the shift reaction being absorbed by the cooling medium flowing through the shell of shell/tube reactor. By “substantially isothermal conditions” is meant that the inlet temperature of the feed gas, as it is introduced into the shift reaction zone, and the outlet temperature of the product gas, as it is removed from the shift reaction zone, differ by no more than 30° F. (preferably no more than 25° F., especially no more than 15° F., in particular no more than 10° F., for example, not more 5° F.).

With respect to cooling mediums, any suitable cooling medium can be used in the shell side of the shell/tube reactor, ice., any medium which can effectively absorb the heat of reaction from the shift reaction such that the reaction can be conducted under substantially isothermal conditions.

Preferably, the cooling medium is boiling water and, during the indirect heat exchange, at least portion of the boiling water is converted into steam. This results in two advantages. First, the process generates steam which can be used as feed for a steam reformer. Second, the generation of steam within the shell of the shell/tube reactor permits the temperature of the shift reaction zone to be controlled by controlling the pressure of steam within the shell. Specifically, the shell side temperature of the combo-boiler, and thus the temperature of the shift reaction zone, can be controlled by controlling the pressure of the steam generated on the shell side.

The process stream cooled in the first process gas cooling zone can be any available process stream from which it is desirable to remove heat. According to a preferred aspect of the invention, the first process gas is the shift reaction feed stream prior to the introduction of this feed stream into the shift reaction zone. In particular, the first process gas is preferably product gas obtained from a steam reformer and, after passage through the first process gas cooling zone, the resultant cooled reformer product gas is used as the feed stream for the shift reaction zone.

In addition to the first process gas cooling zone, the shell/tube reactor can contain further tube zones to permit additional indirect heat exchange between process stream flows and the shell-side cooling medium. For example, the shell and tube reactor can have at least three tube zones and a common shell zone, wherein the at least three tube zones include the shift reaction zone, a first process gas cooling zone (e.g., for cooling the feed gas of the shift reaction zone), and a second process gas cooling zone.

According to one embodiment, the process gas flowing through the second process gas cooling zone can be a flue gas such as the flue gas from the burner or combustion chamber of a steam reformer. In the burner/combustion chamber, a hydrocarbon fuel stream is combusted to generate heat that is transferred to the reforming chamber of the steam reformer. The flue gas from the combustion chamber thus contains a significant amount of heat. Recovery of this heat in the shell/tube reactor enhances the efficiency of the overall steam reformer/shift gas reactor process.

According to another embodiment, the second process gas cooling zone can also function as a reaction zone. For example, the gas flowing into the second process gas cooling zone can be a hydrocarbon feed stream and the tubes of the second process gas cooling zone can be filled with a hydrotreating/desulfurization catalyst such as ZnO promoted with CuMo. It is desirable to reduce the sulfur content of the hydrocarbon feed stream because sulfur compounds can poison the downstream steam reformer catalyst and/or the shift reaction catalyst.

As the hydrocarbon feed stream passes through the tubes of the second process gas cooling zone, heat is initially transferred from the cooling medium to the hydrocarbon feed stream. The feed stream comes into contact with a catalyst such as the ZnO promoted with CuMo and organic sulphur compounds are converted into H₂S. Additionally, due to the presence of hydrogen in the feedstream, the olefins are subjected to hydrotreatment in the presence of the catalyst and become saturated. Thereafter, the ZnO catalyst converts H₂S to ZnS and H₂O. Conversion of H₂S to ZnS and H₂O and hydrotreatment of the olefins are both exothermic reactions. Heat generated by these reactions is removed from the desulfurization zone by the cooling medium. Thus, this embodiment further enhances the overall efficiency of the steam reformer/shift gas reactor process.

Additionally, according to a further embodiment of the invention, the shell and tube reactor has at least four tube zones and a common shell zone, wherein the at least four tube zones include the shift reaction zone, a first process gas cooling zone (e.g., for cooling the feed gas of the shift reaction zone), a second process gas cooling zone (e.g., for cooling the flue gas from the burner of a steam reformer), and a third process gas cooling zone (e.g., wherein the tubes in the third process gas cooling zone contain a hydrodesulfurization catalyst(s) for hydrotreating and desulfurizing the hydrocarbon feed stream of the steam reformer).

Generally, the feed gas to the low-temperature shift reactor (i.e., the shift reaction zone of the shell/tube reactor) is at a temperature of about 350 to 575° F., preferably about 400 to 525° F., especially about 410 to 465° F. ( for example, approximately 410° F.) The feed gas, which contains H₂O and CO, flows down through the catalyst-filled tubes of the shift reaction zone of the shell/tube reactor wherein the water-gas shift reaction takes place converting carbon monoxide and water into carbon dioxide and hydrogen according to the following reaction equation:

CO+H₂O═CO₂+H₂.

The heat generated by this exothermic reaction is removed by the cooling medium flowing through the shell side of the shell/tube reactor. The low-temperature shift reactor is operated in a substantially isothermal manner such that substantially all of the heat generated by the shift reaction is removed by the cooling medium and the reactor maintains a substantially constant bed temperature (e.g., approximately 410° F.). Thus, the process gas exits the unit at approximately the same temperature that it entered. The outlet temperature of the product gas as it is removed from the shift reaction zone differs by no more than 30° F. (preferably no more than 25° F., especially no more than 15° F., in particular no more than 10° F., for example, not more 5° F.) than the inlet temperature of the feed gas to the shift reaction zone.

Operating the low-temperature shift reactor isothermally not only recovers a significant amount of heat, thereby enhancing the overall efficiency of the system, but also reduces damage to the shift catalyst due to exposure to excessively high temperatures. Isothermal operation thus prolongs the life of the catalyst and provides better conversion.

Any suitable low-temperature shift reaction catalyst can be used in the process according to the invention. Low-temperature shift reaction catalysts typically comprise copper and zinc (e.g., based on CuO/ZnO). Other types of low temperature shift catalysts include: copper supported on a transition metal oxide (e.g. zirconia), zinc supported on a transition metal oxide or refractory support (e.g. silica or alumina), supported platinum, supported rhenium, supported palladium, supported rhodium and supported gold.

While the invention has generally been described as employing a low-temperature shift reaction, in an alternative embodiment of the invention the tubes in the shift reaction zone of the shell/tube reactor can instead contain a high-temperature shift reaction catalyst. Suitable catalysts for the high-temperature shift reaction include copper promoted iron-chrome.

In the steam reformer, a mixture of steam and hydrocarbons (e.g., natural gas) are heated and contacted with a steam reforming catalyst. Generally, the steam reforming reaction is performed at a temperature of about 1450 to 1600° F., preferably about 1475 to 1575° F., especially about 1510 to 1560° F. The heated supplied for the steam reforming reaction can be obtained by combustion of a hydrocarbon fuel in a burner chamber. The reaction zone can, for example, contain a fixed bed of steam reformer catalyst, heated by a surrounding burner/combustion chamber chamber. Alternatively, the reaction zone can be in the form of catalyst-filled tubes positioned within the burner/combustion chamber.

Any suitable steam reforming catalyst can be used in the process according to the invention. Suitable catalysts for steam reforming include nickel on an alumina carrier and iron based catalysts

Product gas removed from the steam reformer contains H₂, H₂O, CO, as well as methane, any inerts from the feedstock (e.g. nitrogen, argon, helium) and byproducts such as ammonia. The components of the product gas will, of course, be dependent on the composition of the hydrocarbon feed stream and the steam reforming conditions.

Generally, the temperature of the product gas removed from the steam reformer is about 1450 to 1600° F., preferably about 1475 to 1575° F., especially about 1510 to 1560° F. Often the discharge temperature of the steam reformer product gas is higher than that which is desirable for conducting the low-temperature shift reaction. In such a case, the steam reformer product gas is cooled, typically by indirect heat exchange with a cooling medium. As noted above, according to an aspect of the invention, the steam reformer product gas is cooled in the first process gas cooling zone of the shell/tube reactor, before being introduced into the shift reaction zone.

The hydrocarbon feed stream to the steam reformer will often contain undesirable compounds that can poison the reformer catalyst and/or the shift reactor catalyst. These undesirable compounds include olefins, chlorides and sulfur compounds.

To remove olefins, prior to being introduced into the reformer, the hydrocarbon feed stream can be hydrotreated using hydrogen in the presence of a hydrotreating catalyst. Typically a NiMo catalyst is used as the hydrotreating catalyst. NiMo hydrotreating catalysts are typically used in a temperature range of 400° F. to 750° F. CoMo hydrotreating catalysts can also be used and these are typically used in a temperature range of 550° F. to 750° F. The olefin hydrotreatment is an exothermic reaction and can be performed in a separate vessel or can be performed within a zone of the combo-boiler. If the hydrotreating catalyst is positioned within tubes in a zone of the combo-boiler, the heat generated by the reaction can be transferred to the cooling medium (e.g., water/steam side) in the shell side of the combo-boiler thereby preventing an increase in temperature that could damage the equipment or cause other problems (e.g. cracking the hydrocarbon).

Copending U.S. patent application Ser. No. 11/694,309, filed Mar. 30, 2007, the entire disclosure of which is hereby incorporated by reference, discloses a process and system for reducing the olefin content of a hydrocarbon feed steam in the production of a hydrogen-enriched gas.

If chlorides are present in the hydrocarbon feed stream to the steam reformer, these can also be removed by hydrotreatment, for example, using a CoMo or NiMo hydrotreating catalyst. The hydrotreatment catalyst converts the chlorides into HCl which is then removed by passage through a bed of Na₂O to form NaCl and H₂O. The conversion of chlorides into HCl is an exothermic process, but because chloride levels are typically very low, the heat generated is minimal. The chlorides conversion process typically is performed at a temperature in the range of 50-700° F. The chloride conversion catalyst bed would generally be positioned downstream from the olefin hydrotreating catalyst bed (if one is present) and upstream of a desulfurizing catalyst bed (if one is present).

If sulfur compounds are present in the hydrocarbon feed stream to the steam reformer, they can also be removed by hydrotreatment. Using a hydrotreating catalyst such as CoMo or NiMo, the sulfur compounds are hydrotreated to form H₂S. Alternatively, if the sulfur compounds are simple light mercaptans, then they can be thermally broken down, without requiring the use of a hydrotreating catalyst, at temperatures around 600-700° F. Once the sulfur compounds are converted, the resultant H₂S can be removed by passage through a bed of ZnO, which leads to the formation of ZnS and H₂O. The conversion process is exothermic, but because the sulfur levels are typically very low the heat generated is minimal. These hydrotreating catalysts are active from ambient temperature to 800° F., typically 300° F. to 750° F. It is possible to combine the hydrotreating and desulfurizing steps into one step by using ZnO promoted with CuMo as the catalyst.

The desulfurization process (i.e., hydrotreatment of sulfur compounds and H₂S removal) can be performed in a separate vessel. Alternatively, as discussed above, desulfurization can be performed in one of the process gas cooling zones of the shell/tube reactor wherein the tubes of the process gas cooling zone are filled with a suitable hydrotreatment catalyst. For example, the tubes can contain a first bed of hydrotreatment catalyst followed by a bed of ZnO catalyst, or they could contain a bed of ZnO catalyst promoted with CuMo.

Other processes for desulfurizing the hydrocarbon feed stream include amine systems and membranes. Additionally, sulfur can be removed using activated carbon which can be regenerated using steam.

According to a further aspect of the invention, there is provided an apparatus for hydrogen generation involving steam reforming and a water gas shift reaction, the apparatus comprising:

a desulfurizer containing a bed of hydrodesulfurization catalyst, the desulfurizer having an inlet for introducing a hydrocarbon feed stream (e.g., natural gas) and an outlet for discharging a desulfurized hydrocarbon feed stream;

a steam reformer comprising a combustion chamber and a reformer chamber, the reformer chamber containing a steam reformer catalyst, the reformer having a desulfurized hydrocarbon feed stream inlet for introducing a desulfurized hydrocarbon feed stream into the reformer chamber, the feed stream inlet being in fluid communication with the outlet of the desulfurizer,

the reformer further comprising a reformed product gas outlet for discharging reformed product gas containing H₂, H₂O, and CO, means for introducing hydrocarbon fuel and an oxygen-containing gas into the combustion chamber, and means for removing flue gas from the combustion chamber, and

means for combining desulfurized hydrocarbon feed stream with steam upstream of the desulfurized hydrocarbon feed stream inlet and/or a steam inlet for introducing steam into the reformer chamber of the steam reformer; and

a combo-boiler in the form of a shell/tube reactor, the combo-boiler comprising a common shell zone, a first tube zone positioned within the common shell zone, and a second tube zone positioned within the common shell zone,

the first tube zone having a first inlet for introducing reformed product gas and a first outlet for discharging heated reformed product gas, the first inlet being in fluid communication with the reformed product gas outlet of the steam reformer,

the second tube zone having a second inlet for introducing heated reformed product gas and a second outlet for discharging shift reaction product gas containing H₂ and CO₂, wherein the tubes of the second zone contain a shift reaction catalyst, and

the common shell zone having a cooling medium inlet and a cooling medium outlet.

According to a further apparatus aspect of the invention, the combo-boiler further comprising a third tube zone positioned within the common shell zone, the third tube zone having a flue gas inlet and a flue gas outlet, the flue gas inlet being in fluid communication with the means for removing flue gas from the combustion chamber of the steam reformer.

According to a further apparatus aspect of the invention, the desulfirizer is a further tube zone within the common shell zone of the combo-boiler.

Upon further study of the specification and appended claims, further aspects and advantages of this invention will become apparent to those skilled in the art.

### BRIEF DESCRIPTION OF THE DRAWINGS

Various other features and attendant advantages of the present invention will be more fully appreciated as the same becomes better understood when considered in conjunction with the accompanying drawings, in which like reference characters designate the same or similar parts throughout the several views, and wherein:

FIG. 1 illustrates a flow chart of a process embodiment according to the invention; and

FIG. 2 shows a more detailed view of the shell/tube reactor (combo-boiler) of the invention.

### DETAILED DESCRIPTION OF THE DRAWINGS

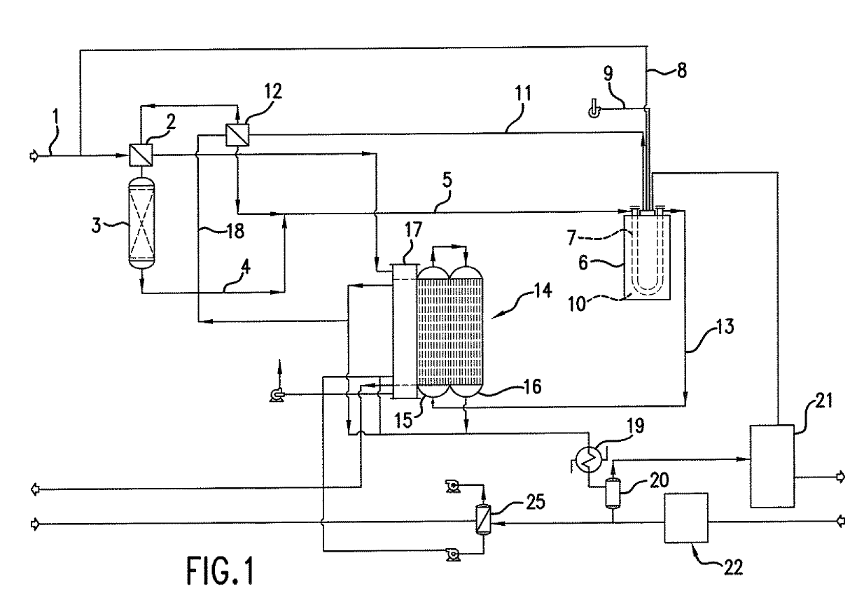

In FIG. 1, a hydrocarbon feed gas 1 at a temperature from ambient temperatures to about 300° F., is subjected to indirect heat exchange in a heat exchanger 2 and heated from about ambient temperature to about 300-400° F., e.g., 375° F. The heated hydrocarbon feed gas is introduced into a desulfurizer 3 wherein the heated hydrocarbon feed gas contacts a hydrotreating/desulfurizing catalyst like ZnO promoted with CuMo. In the desulfurizer 3, sulfur compounds such as mercaptans are converted into H₂S and removed. Desulfurized hydrocarbon feed gas is removed from desulfurizer 3 and combined with steam via line 18.

The resultant desulfurized hydrocarbon feed/steam mixture 5 is introduced into the reaction chamber 7 of a steam reformer 6 where it is contacted with a steam reformer catalyst such as a nickel catalyst on a carrier. Alternatively, the desulfurized hydrocarbon feed and steam can be introduced separately into the steam reformer. A separate second hydrocarbon stream 8, along with air or oxygen 9 (either separately or as a mixture with the second hydrocarbon stream), is introduced into the combustion chamber 10 which surrounds the reaction chamber. The second hydrocarbon stream is combusted in the burner chamber thereby heating the reaction chamber to the desired temperature for steam reforming, e.g., approximately 410° F. In the steam reformer, the desulfurized hydrocarbon feed/steam mixture is converted into a product gas stream containing H₂, CO, and H₂O, methane, any inerts from the feedstock (e.g. nitrogen, argon, helium) and byproducts such as ammonia.

The flue gas 11 from the burner chamber can be used to heat other processes gases. For example, the flue gas can be used in indirect heat exchanger 12 to heat steam prior to introduction into the steam reformer. Additionally or alternatively, the flue gas can be used in indirect heat exchanger 2 to heat the hydrocarbon feed gas prior to its introduction into the steam reformer.

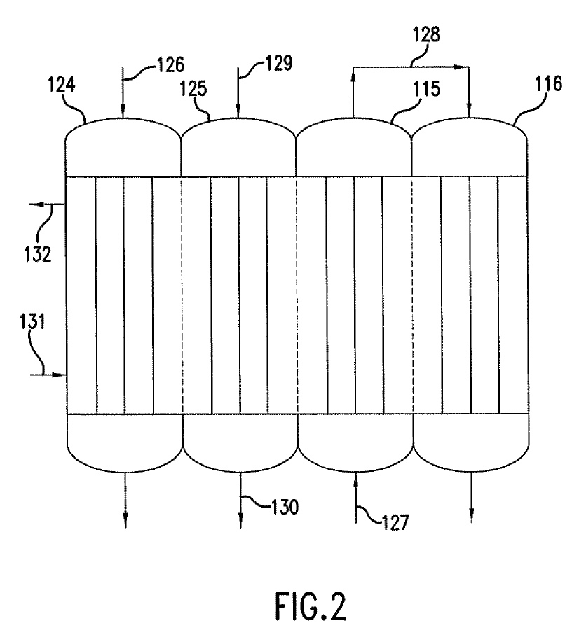

According to a further aspect of the invention, the flue gas is used as a process stream flowing through one of the process gas cooling zones to the of the shell/tube reactor (discussed in more detail below). For example, when the cooling medium is water, the heat from the flue gas, and other process streams, can be used to generate steam which can be used as a source of steam for the steam reformer. See FIG. 2.

After discharge from the steam reformer, as shown in FIG. 1, at least a part of the reformer product gas stream 13 is delivered to a combo-boiler 14. This apparatus is referred to as a combo-boiler in that it provides indirect heat exchange between a cooling medium preferable boiling water) and two or more process streams. Furthermore, the combo-boiler at least in part functions as a reactor since it contains a reaction zone for performing a water gas shift reaction, preferably a low-temperature water gas shift reaction.

The combo-boiler is in the form of shell/tube reactor comprising at least two tube zones 15, 16 positioned within a common shell. One of the tube zones is the shift reaction zone. In this tube zone, the tubes are filled with a shift reaction catalyst such as a catalyst based on CuO/ZnO. Another tube zone functions as the first process gas cooling zone. The shell/tube reactor (combo-boiler) is shown in more detail in FIG. 2.

Referring to FIG. 1, the reformer product gas stream is introduced into section 15 of the combo-boiler. This section is a first process gas cooling section. The reformer product gas flows through tubes in this first process gas cooling section wherein it undergoes indirect heat exchange with the boiling water flowing through the shell side of the combo-boiler 14 as a cooling medium. After discharge from first process gas cooling section 15, the reformer product gas stream is introduced into section 16 of the combo-boiler the shift reaction zone. The reformer product gas flows through the catalyst-filled tubes of the shift reaction zone wherein H₂O and CO are converted into CO₂ and H₂ in accordance with the water gas shift reaction. As a result of the heat exchange with the cooling medium, the exothermic water gas shift reaction is conducted under substantially isothermal conditions in the shift reaction zone 16.

In FIG. 1, the third section of the combo-boiler 17 is a second process gas cooling zone. As previously described, in this zone flue gas from the steam reformer flows through tubes whereby it undergoes indirect heat exchange with water.

Although not shown in FIG. 1, the comb-boiler is also provided with a process gas by-pass line around the low-temperature shift reaction zone. This by-pass line is used to by-pass the low-temperature shift reaction zone during start-up to prevent condensation and dust from damaging the catalyst in the low-temperature shift reaction zone.

In FIG. 1, during the heat exchange in the combo-boiler, at least a portion of the water functioning as a cooling medium is converted into steam. A portion of this steam 18, after undergoing a further indirect heating with the flue gas in heat exchanger 12, is combined with the desulfurized hydrocarbon feed gas to form the feed mixture 5 introduced into the steam reformer. Also, by controlling the steam pressure within the shell side of the reactor, the temperature of the shift reaction zone 16 can be controlled.

The product gas, now enriched with H₂, is removed from the combo-boiler, cooled in an indirect heat exchanger 19 against, for example, ambient air or water, and delivered to gas/liquid separator 20. As a result of this heat exchange, water present in the product gas is condensed and can be removed from the bottom of separator 20. If water is used as the cooling medium, heat exchanger 19 can be used to preheat water for use as the cooling medium in the combo-boiler (assuming that the water is of proper quality).

The gas removed from the top of the separator 20 can be subjected to further purification to separate product hydrogen gas from residual gases. The most common purification processes are those that work better at low temperature (PSA, membranes, amine wash). For example, as shown in FIG. 1, the gas removed from the top of the separator 20 is introduced into a pressure swing adsorber [PSA] system 21. Hydrogen is removed as a product stream from the PSA, and the residual gases can be, for example, sent to the burner chamber of the steam reformer.

Condensed water removed from the bottom of the separator can be combined with make-up water, if necessary, and delivered to the shell side of the combo-boiler where the water acts as the cooling medium. Prior to being combined with the condensate, the make-up water can be subjected to treatment in 22 to insure that the water is of sufficient quality for use in the reformer. It is advantageous to use relatively high quality steam in the reformer (e.g. no sulphur or chlorides). Treatment zone 22 can be a demineralizer or reverse osmosis system. Depending on the water quality, softeners may also be used.

The combined water stream can then be treated in a stripper 23 where nitrogen is used to strip out residual O₂, CO₂, H₂, CO and other dissolved gases. A traditional deaerator using steam can also be used.

FIG. 2 illustrates a further embodiment of the invention wherein the combo-boiler (shell/tube reactor) has four tube sections. The first tube section at the left of the combo-boiler represents a desulfurization zone. The hydrocarbon feed gas is introduced into the desulfurization zone via line 126 and passes through tubes filled with desulfurization catalyst. As the hydrocarbon feed gas flows through the catalyst-filled tubes of the desulfurization zone, it is cooled by indirect heat exchange with the cooling medium flowing through the shell side of the combo-boiler, e.g., water.

The resultant desulfurized hydrocarbon feed gas is removed from the combo-boiler and delivered to the steam reformer. Product gas from the steam reformer is introduced into a first process cooling zone of the combo-boiler via line 127. The cooled product gas is then delivered to the shift reaction zone via line 128. Flue gas from the steam reformer is introduced into the final tube section of the combo-boiler via line 129 and removed via line 130. Cooling medium is introduced into the shell side of the combo-boiler via line 131 and removed via line 132.

Without further elaboration, it is believed that one skilled in the art can, using the preceding description, utilize the present invention to its fullest extent. The preceding preferred specific embodiments are, therefore, to be construed as merely illustrative, and not limitative of the remainder of the disclosure in any way whatsoever.

From the foregoing description, one skilled in the art can easily ascertain the essential characteristics of this invention and, without departing from the spirit and scope thereof, can make various changes and modifications of the invention to adapt it to various usages and conditions.

1. A process for performing a shift reaction, said process comprising;
introducing a feed gas comprising H₂O and CO into a combo-boiler, said combo-boiler comprising a shell and tube reactor having at least two tube zones and a common shell zone, wherein said at least two tube zones include a shift reaction zone and a first process gas cooling zone, the tubes of said shift reaction zone containing a shift reaction catalyst and wherein said feed gas is introduced into the tubes of said shift reaction zone to convert H₂O and CO into CO₂ and H₂,
introducing a first process gas into the tubes of said first process gas cooling zone,
introducing a cooling medium into the shell side of said combo-boiler for cooling said shift reaction zone and said first process gas cooling zone, wherein said cooling medium undergoes indirect heat exchange with said feed gas and said first process gas, whereby said shift reaction zone is operated under isothermal conditions,
removing a product gas containing CO₂ and H₂ from the tubes of said shift reaction zone,
removing a cooled first process gas from the tubes of said first process gas cooling zone, and
removing said cooling medium from said shell side of said combo-boiler.

2. A process according to claim 1, wherein the temperature of said feed gas as it is introduced into said shift reaction zone and the temperature of said product gas as it is removed from said shift reaction zone differ by no more than 25° F.

3. A process according to claim 1, wherein said cooling medium is boiling water and at least portion of said boiling water is converted into steam.

4. A process according to claim 3, wherein the shell side temperature of said combo-boiler is controlled by controlling the pressure of the steam generated on said shell side.

5. A process according to claim 1, wherein said cooling medium is not water.

6. A process according to claim 1, wherein said first process gas is said feed stream prior to the introduction of said feed stream into said shift reaction zone.

7. A process according to claim 1, wherein said first process gas is an exhaust gas removed from a steam reformer.

8. A process according to claim 1, wherein said shell and tube reactor has at least three tube zones and a common shell zone, wherein said at least three tube zones include said shift reaction zone, said first process gas cooling zone, and a flue gas cooling zone, and
wherein a flue gas is introduced into the tubes of said flue gas cooling zone and a cooled flue gas is removed from the tubes of said second process gas cooling zone.

9. A process according to claim 8, wherein said first process gas is said feed stream prior to the introduction of said feed stream into said shift reaction zone.

10. A process according to claim 9, wherein said flue gas is an exhaust gas removed from a steam reformer.

11. A process for performing steam reforming and a shift reaction, said process comprising;
subjecting a first hydrocarbon feed gas to desulfurization,
introducing the resultant desulfurized first hydrocarbon feed gas and steam into a reforming chamber of a steam reformer, said steam reformer comprising said reforming chamber and a separate burner or combustion chamber, wherein the desulfurized first hydrocarbon feed gas is subjected to steam reforming to produce steam-reformed gas comprising H₂O and CO,
combusting a second hydrocarbon feed gas and an oxygen-containing gas in said burner or combustion chamber of said steam reformer to provide indirect heat for steam reforming said desulfurized first hydrocarbon feed gas,
introducing the steam-reformed gas comprising H₂O and CO into a combo-boiler, said combo-boiler comprising a shell and tube reactor having at least two tube zones and a common shell zone, wherein said at least two tube zones include a shift reaction zone and a first process gas cooling zone, the tubes of said shift reaction zone containing a shift reaction catalyst,
introducing a first process gas into the tubes of said first process gas cooling zone,
introducing steam-reformed gas comprising H₂O and CO into the tubes of said shift reaction zone, wherein the steam-reformed gas undergoes a water-gas shift reaction in said shift reaction zone to convert H₂O and CO into CO₂ and H₂,
introducing a cooling medium into the shell side of said combo-boiler for cooling said shift reaction zone and said first process gas cooling zone, whereby the cooling medium undergoes indirect heat exchange with said first process gas and indirect heat exchange with said steam-reformed gas as it undergoes the water-gas shift reaction, whereby said shift reaction zone is operated under isothermal conditions,
removing a product gas containing CO₂ and H₂ from the tubes of said shift reaction zone,
removing a cooled first process gas from the tubes of said first process gas cooling zone, and
removing cooling medium from the shell side of said combo-boiler.

12. A process according to claim 11, wherein the temperature of said feed gas as it is introduced into said shift reaction zone and the temperature of said product gas as it is removed from said shift reaction zone differ by no more than 25° F.

13. An apparatus for hydrogen generation involving steam reforming and a water gas shift reaction, the apparatus comprising:
a desulfurizer containing a bed of desulfurization catalyst, said desulfurizer having an inlet for introducing a hydrocarbon feed stream and an outlet for discharging a desulfurized hydrocarbon feed stream,
a steam reformer comprising a burner chamber and a reaction zone, said reaction zone containing a steam reformer catalyst, said reformer having a desulfurized hydrocarbon feed stream inlet for introducing a desulfurized hydrocarbon feed stream into said reaction zone, said feed stream inlet being in fluid communication with said outlet of said desulfurizer,
said reformer further comprising a reformed product gas outlet for discharging reformed product gas containing H₂, H₂O, and CO, means for introducing hydrocarbon fuel and an oxygen-containing gas into said burner chamber, and means for removing flue gas from said burner chamber,
either means for combing desulfurized hydrocarbon feed stream with steam upstream of said desulfurized hydrocarbon feed stream inlet or a steam inlet for introducing steam into said reaction zone of said steam reformer, and
a combo-boiler in the form of a shell/tube reactor, said combo-boiler comprising a common shell zone, a first tube zone positioned within said common shell zone, and a second tube zone positioned within said common shell zone,
said first tube zone having a first inlet for introducing reformed product gas and a first outlet for discharging heated reformed product gas, said first inlet being in fluid communication with said reformed product gas outlet of said steam reformer,
said second tube zone having a second inlet for introducing heated reformed product gas and a second outlet for discharging shift reaction product gas containing H₂ and CO₂, wherein the tubes of said second zone containing a shift reaction catalyst,
said common shell zone having a cooling medium inlet and a cooling medium outlet.

14. An apparatus according to claim 13, wherein said combo-boiler further comprises a third tube zone positioned within said common shell zone, said third tube zone having a flue gas inlet and a flue gas outlet, said flue gas inlet being in fluid communication with said means for removing flue gas from said burner chamber.

15. An apparatus according to claim 13, wherein said desulfurizer is a further tube zone within said common shell zone of said combo-boiler.

16. An apparatus according to claim 14, wherein said desulfurizer is a further tube zone within said common shell zone of said combo-boiler.
